(19) United States
(12) Patent Application Publication
(10) Pub. No.: US 2006/0283537 A1
(43) Pub. Date: Dec. 21, 2006

(54) METHOD AND DEVICE FOR SELECTIVELY REMOVING A SURPLUS INTERLAYER PORTION IN A LAMINATED GLASS STRUCTURE

(76) Inventor: Peter Lisec, Hausmening-Amstetten (AT)

Correspondence Address: EDELL, SHAPIRO & FINNAN, LLC, 1901 RESEARCH BOULEVARD, SUITE 400, ROCKVILLE, MD, 20850, US

(21) Appl. No.: 11/424,650

(22) Filed: Jun. 16, 2006

(30) Foreign Application Priority Data
Jun. 16, 2005 (DE) 10 2005 027 964.3

(51) Int. Cl. B32B 17/00; B29C 63/00

(52) U.S. Cl. 156/101; 156/344; 156/584

(57) ABSTRACT

A tool includes a rotating abrasive disk that removes the lateral excess portion of a plastic sheet positioned between the panes of a laminated glass structure. Specifically, the excess portion of the plastic sheet may be removed along on two mutually rectangular edges of the laminated glass structure. The rotating disk may be used with a scratching table or a combined scratching and breaking table, with the disk arranged in a stationary manner on a longitudinal edge and with a further rotating abrasive disk arranged on a carriage that moves in a rectangular manner relative to the direction of transport of the laminated glass structure.

### CROSS REFERENCE TO RELATED APPLICATIONS

This application claims priority under 35 USC §119 to German Application No. DE 10 2005 027 964.3, filed on 16 Jun. 2005 and titled “A Method and Apparatus for Removing the Excess Portion of a Plastic Sheet in Laminated Glass Sheets,” the disclosure of which is hereby incorporated by reference in its entirety.

### FIELD OF THE INVENTION

The invention is directed to a device and process for forming a laminated glass structure and, in particular, to a process and device for removing excess adherent material extending from the edge of the laminated glass structure using a rotating disk.

### BACKGROUND

Laminated glass structures are formed from two or more sheet glass or mirror glass panes that are secured to each other using an interlayer of adhesive, e.g., a plastic sheet. The adhesive, which may include as polyvinyl butyral, is positioned between the two panes of glass. The bonding process is normally carried out under conditions of elevated pressure and temperature in an autoclave, during which shrinkage of the interlayer material may occur. It is therefore necessary to cut the interlayer material initially to a shape and size larger than that of the panes of glass. Even after the autoclave process, surplus adhesive protrudes irregularly by approximately 1 to 2 mm from all edges of the raw laminated glass structure. The surplus interlayer—i.e., the portion protruding beyond the edges of the laminated glass structure—must be removed, since further processing steps (e.g., obtaining the respectively required laminated glass sheet pre-cuts or formats) typically require precise positioning and guidance of the raw laminated glass structure over one of its two longitudinal edges, irrespective of whether the laminated glass sheet is further processed in a horizontal position, a vertical (upright) position, or an inclined position.

Traditionally, the excess portion was removed in a time-consuming and laborious manner by hand, such that it was cut off utilizing a sharp blade. Mechanised efforts to remove the excess portion have not proven to be suitable. For example, EP 0499371 (Walker et al.) discloses the use of an abrasive belt guided along the edge of the laminated glass structure. The belt is pressed against the circumferential edge of the structure, with the belt rotating transversely with respect to the edge. The belt is unsupported in the area contacting the edge, which causes the belt to bend around the edge. As a result, the edge of the laminated glass structure becomes rounded, which is undesirable. In order to counteract such rounding, it is proposed that a belt be used with mild abrasive properties. These belts, however, have a low service life, requiring constant belt changing and increasing set-up costs.

U.S. Pat. No. 2,022,530 (White) discloses a method for producing laminated glass sheets in which a continuous channel is formed along the circumferential edge of the laminated glass structure, which is then filled with sealing material. The sealing material is removed from the edge of the laminated structure using a polishing/grinding tool. A solvent flow is directed over the tool to remove sealing material from the tool surface.

U.S. Pat. No. 4,592,261 (Miyaji et al.) discloses a cutting device including a band cutter extending between two pulleys. The band removes the excess portion of the plastic sheet. The device includes a sliding piece that contacts the rear face of the band cutter to remove adherent from the its surface, as well as a side plate arranged to separate extra interlayer fringe cut off by the endless band cutter from the circumference of the glass structure.

### SUMMARY OF THE INVENTION

The invention is directed toward a method and device operable to remove adherent material from a laminated glass structure while leaving the edge of the structure intact (i.e., without causing rounding of the edges). In particular, the current invention relates to a removal tool including rotating disk with abrasive particles. The disk may tangentially contact with the edge of the glass structure, removing the excess interlayer material (i.e., the adherent material extending beyond the structure edge) to create an edge wherein the adherent is generally flush with the adjoining panes of glass.

### DETAILED DESCRIPTION OF THE INVENTION

As noted above, a laminated glass structure is formed when a first glass pane is secured to a second glass pane via an adherent material. The adherent material may include, but is not limited to, plastic. By way of specific example, the adherent material may be a plastic sheet with dimensions larger than that of the panes of glass. The plastic sheet may be applied (e.g., via extrusion) to one or both of the glass panes. The panes are then secured together, with the plastic sheet sandwiched between the two glass panes, forming an interlayer. The laminated structure may include additional glass panes secured in a similar manner.

The portion of the plastic sheet extending beyond the edge of the glass panes may be removed via a tool. The tool may comprise a disk operable to rotate about its axis. The surface of the disk includes an abrasive material. In particular, the circumferential surface of the disk may include abrasive material. Among the abrasive disks of different composition that are commercially available, such disks are most suitable which are have sufficient hardness to remove the plastic while minimally damaging the edges of the laminated glass structure. By way of example, the abrasive material may include plastic-bound and/or elastomer-bound grained abrasives. The disks are driven by a high speed motor. For example, compressed-air motors are may be used to drive the rotation of the disks.

In operation, the tool may tangentially contact the edge of the laminated glass structure. The disk may be moved along the edge of the structure, with the perimeter of the rotating disk removing the exposed interlayer, making it generally flush with the edge. When the laminated glass structure is generally rectangular, it is usually sufficient that the excess portion of the interlayer is removed only at two mutually perpendicular edges of the laminated glass structure because the two remaining edges are those of a longitudinal strip and a transversal strip which each remain as useless residue after the cut is made. For example, the laminated glass structure may remain stationary while a first tool is guided along a first edge of the laminated glass structure (e.g., the edge running in the Y-direction). Then, a second tool may be guided along a second edge of the laminated glass structure that is perpendicular to the first edge (e.g., the edge running in the X-direction). Alternatively, the first and second tools may be stationary, with the laminated glass structure selectively moved into contact with one or more of the disks. These steps can also be performed in a reverse sequence. Principally, a rotating tool is sufficient which moves along one edge at first, e.g. the edge of the laminated glass structure extending in the Y-direction, but can also be brought to a fixed position relative to the other edge of the laminated glass structure, which is then transported with its second edge along the tool in the X-direction.

The removed excess portion is drawn off in the direct vicinity of the rotating tool. For example, at least one brush (e.g., a rotating brush) and/or one suction apparatus can be associated with the tool and especially each rotating disk, so that soiling of the laminated glass structure and contamination of the working environment by abraded particles of the excess portion of the plastic sheet (interlayer), as well as the abraded parts from the abrasive disk may be avoided. The excess portion of the plastic sheet may also be drawn away from the laminated structure and/or tool using a transport mechanism and, optionally, a fixing mechanism (such as a suction unit), a scratching station, and/or a combined scratching and breaking station.

The laminated glass structure may be supported on a supporting surface such as a table surface or the lateral supporting surface of a scratching or breaking station that is slightly inclined against the perpendicular. In the case of a laminated glass structure that is processed and transported while positioned horizontally, the transport mechanism may include a series of conveyor belts integrated into the table surface. In the case of laminated glass sheets processed and transported while positioned vertically (upright), he transport mechanism may include a series of rollers or other horizontal conveyors of such a station.

When the laminated glass structure is processed in the upright position, the longitudinal edge of the supporting surface (e.g., the edge proximate the bottom of the supporting surface) includes the rotating abrasive disk is arranged in such a way that the abrasive circumferential surface of the disk contacts the horizontal edge (the edge running along the X-axis) of the laminated glass structure in a straight tangential manner. The tool may be stationary, with the laminated glass structure moved with respect to the tool. As a result, the transport of the laminated glass structure along the rotating disk leads to a sharp-edged removal of its excess portion of the plastic sheet.

A carriage on a guide bar or guide column includes a rotating tool capable of moving along a vertical edge of the laminated glass structure (an edge running along the Y-axis). For example, the tool may be positioned along the front vertical edge of the laminated structure, i.e., the edge that is at the front relating to the direction of transport. In order to provide the tool or its rotating disk with sufficient space, the supporting surface may include a slot or be divided at the level of the tool. The side edges of the supporting surface (the edges parallel to the direction of transport of the laminated glass structure) may further include a stop rail for positioning and guiding the laminated glass structure during its transport.

In another embodiment, the device may be a substantially integrated component of an existing scratching and/or breaking station. In addition, the second tool may further be mounted on the same carriage as other mechanisms (e.g., the scratching mechanism).

Under the precondition that the carriage can be moved to an end position in which the circumferential surface of the abrasive disk tangentially touches a longitudinal edge of the laminated glass structure, the same tool can be used for removing the excess portion of the interlayer both for the front vertical edge of the laminated glass structure, as well as the horizontal edge of the laminated glass structure.

A single tool with one rotating disk is also only required when the carriage carrying the tool is displaceable both horizontally and vertically, i.e., along the horizontal and vertical edges of the laminated glass structure. Thus, the carriage may be displaced perpendicular to the direction of transport, but may further be situated on a bridge displaced in the direction of the sheet transport (e.g., the X-direction), so that the tool, when the carriage is positioned on the side of the horizontal edge of the laminated glass structure, can move over at least one horizontal edge of the laminated glass structure while the structure itself remains stationary, being held in position by, for example, vacuum suction.

As is currently common practice, all positioning and transport as well as machining processes can be carried out in a numerically controlled manner, i.e. in a fully automatic way.

I claim:

1. A method of producing a laminated glass structure comprising the steps of:
(a) providing a laminated glass structure having a first edge and a second edge and including a first glass pane, a second glass pane, and a interlayer of adherent material disposed between the first glass pane and the second glass pane, wherein a portion of the interlayer extends beyond at least one of the first edge and the second edge; and
(b) removing the extending interlayer portion using a removal tool comprising a rotating abrasive disk.

2. The method of claim 1, wherein the perimeter of the rotating disk contacts the extending interlayer portion to remove the portion while leaving the edge of the laminated glass structure generally intact.

3. The method of claim 1, wherein:
the first and second edges are mutually perpendicular;
the interlayer extends beyond each of the first edge and the second edge; and step (b) comprises (b.1) removing the extending portions of the interlayer from both the first edge and the second edge.

4. The method of claim 1, wherein the laminated glass structure is stationary and step (b) comprises (b.1) progressively removing the extending portion of the interlayer by driving the removal tool in a direction parallel to the first edge of the laminated glass structure.

5. The method of claim 1, wherein the removal tool is stationary and step (b) comprises (b.1) progressively removing the extending portion of the interlayer by driving the laminated glass structure in a direction parallel to the rotating disk.

6. The method of claim 1, wherein the interlayer extends beyond each of the first edge and the second edge and step (b) comprises:
(b.1.) maintaining the laminated glass structure in a stationary position while driving a first removal tool parallel to the first edge of the laminated glass structure to remove the extending port of the interlayer along the first edge; and
(b.2) maintaining a second removal tool in a stationary position while driving the laminated glass structure in a direction parallel to the second tool to remove the extending portion of the interlayer along the second edge.

7. The method of claim 6, wherein the first edge and the second edge are mutually perpendicular.

8. The method of claim 1, wherein step (b) comprises:
(b.1.) maintaining the laminated glass structure in a stationary position;
(b.2) driving a first removal tool parallel to the first edge of the laminated glass structure to remove the extending portion of the interlayer along the first edge; and
(b.3) driving a second removal tool in a direction parallel to the second edge to remove the extending portion of the interlayer along the second edge.

9. The method of claim 8, wherein the first edge and the second edge are mutually perpendicular.

10. The method of claim 1 further comprising (c) drawing the removed interlayer portion away from the tool.

11. The method of claim 10, wherein step (c) comprises (c.1) vacuuming the removed interlayer portion away from the tool.

12. The method of the claim 10, wherein a scratching station including a transport mechanism draws the removed interlayer portion away from the tool.

13. The method of the claim 10, wherein a combined scratching and breaking station including a transport mechanism draws the removed interlayer portion away from the tool.

14. A device operable to remove the lateral excess portion of interlayer disposed between panes of a laminated glass structure including a first edge and a second edge, the device comprising:
a supporting surface configured to support the laminated glass structure;
a transport mechanism operable to linearly move the laminated glass structure on or along the supporting surface;
a tool fixed to the supporting surface comprising a rotating abrasive disk configured to tangentially contact the first edge of the laminated glass structure; and
a tool moveable with respect to the supporting surface comprising a rotating abrasive disk configured to tangentially contact the second edge of the laminated glass structure.

15. The device of claim 14, wherein the moveable tool is driven in a direction perpendicular to the direction in which the laminated glass structure is transported by the transport mechanism.

16. The device of claim 15, wherein the first edge and the second edge are mutually perpendicular.

17. The device of claim 14, wherein each tool further comprises at least one brush.

18. The device of claim 17, wherein the brush is configured to rotate with respect to the tool.

19. The device of claim 14 further comprising a vacuum operable to draw the removed portion of plastic sheet away from the tool.
